(19) United States
(12) Patent Application Publication
(10) Pub. No.: US 2025/0371850 A1
(43) Pub. Date: Dec. 4, 2025

(54) TRAINING IMAGE REPRESENTATION NEURAL NETWORKS USING CROSS-MODAL INTERFACES

(71) Applicant: DeepMind Technologies Limited, London (GB)

(72) Inventors: Chen Wei, Jersey City (NJ); Chenxi Liu, Baltimore, MD (US); Siyuan Qiao, Santa Clara, CA (US); Zhishuai Zhang, Baltimore, MD (US)

(21) Appl. No.: 18/935,365

(22) Filed: Nov. 1, 2024

Related U.S. Application Data
(60) Provisional application No. 63/652,591, filed on May 28, 2024.

(51) Int. Cl. G06V 10/774; G06F 40/284; G06V 10/82

(52) U.S. Cl. CPC G06V 10/774; G06F 40/284; G06V 10/82

(57) ABSTRACT

Methods, systems, and apparatus, including computer programs encoded on computer storage media, for training an image representation neural network.

### CROSS-REFERENCE TO RELATED APPLICATION

This application claims priority to U.S. Provisional Application No. 63/652,591, filed on May 28, 2024. The disclosure of the prior application is considered part of and is incorporated by reference in the disclosure of this application.

### BACKGROUND

This specification relates processing images using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers in one or more locations that trains an image representation neural network that is configured to receive an input image and to process the input image to generate a representation of the input image as a set of text tokens from a vocabulary of text tokens.

In particular, the system trains the image representation neural network by using text as a “cross-modal interface” between the output of the image representation neural network and a text-conditional image generation neural network.

Once the image representation neural network has been trained, the representations generated by the trained image representation neural network can be used for any of a variety of downstream tasks. For example, a representation of a new image generated by the downstream neural network can be provided as input to a downstream neural network, i.e., in place of the new image and without requiring that the downstream neural network be capable of processing image data.

Particular embodiments of the subject matter described in this specification can be implemented so as to realize one or more of the following advantages.

This specification describes techniques for effectively training an image representation neural network that maps an input image to a set of text tokens that describe the input image. In particular, the system uses text as a “latent space” during training by employing a text-to-image generative neural network, e.g., a diffusion neural network, to process the text generated by the image representation neural network to generate an output that is used to train the image representation neural network. As a result, the latent text that is generated by the image representation neural network, though potentially mixing semantic concepts together to be a “scrambled caption” of the input image, is a description of the input image that is both precise and comprehensive. This allows the latent text to, after training, be used an effective representation of the corresponding image for any of a variety of downstream tasks. Advantageously, this training requires no extra supervision is other than images themselves.

In more detail, recent generative text-to-image models excel at converting arbitrary rich text of, e.g., tens of words, to highly detailed images that closely follow the prompts. In other words, these generative models have the capability to process complex text into visually coherent outputs. By employing one of these generative text-to-image models as the decoder in an auto-encoder framework that uses text as the latent representation (with the image representation neural network used as the encoder) during training, the optimized image representation neural network explores the wide latent space of text and unpacks the enormous visual-language knowledge encapsulated within the generative model, resulting in high quality text representations.

Once trained, the representations generated by the image representation neural network can be used for any of a variety of downstream tasks. For example, the representations can be used to “inject” image content into models, e.g., large language model (LLMs), that were not trained to process images, without requiring any additional retraining of these models.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example training system.

FIG. 2 is a flow diagram of an example process for training the image representation neural network.

FIG. 3 is a flow diagram of an example process for training the image representation neural network when the image generation neural network is a diffusion neural network.

FIG. 4 shows an example of downstream tasks that can be performed after the training of the image representation neural network.

Like reference numbers and designations in the various drawings indicate like elements.

### DETAILED DESCRIPTION

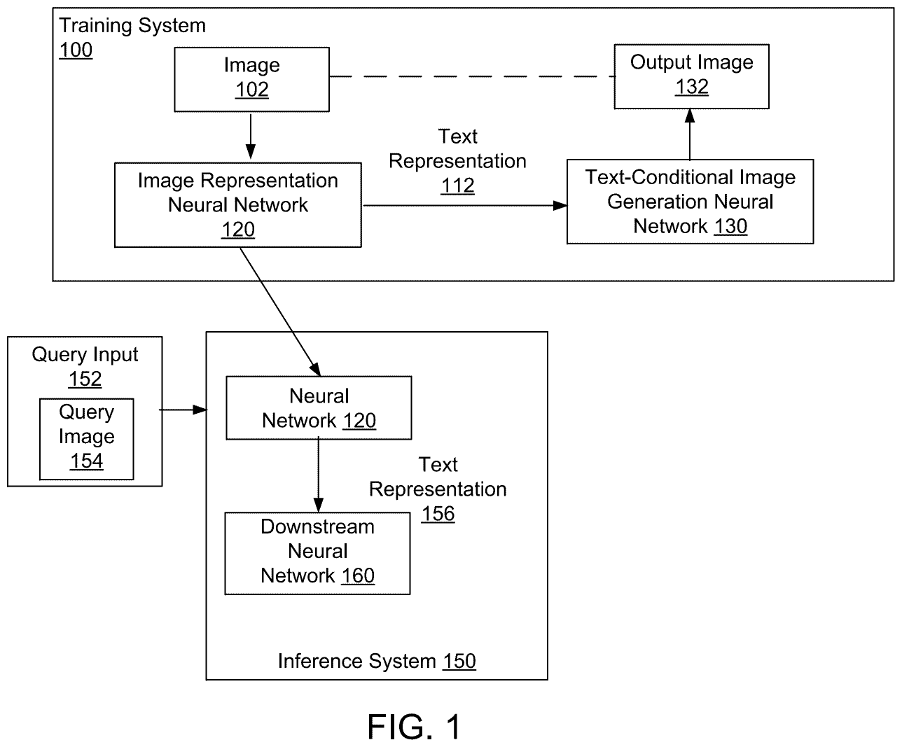

FIG. 1 is a diagram of an example training system 100. The training system 100 is an example of a system implemented as computer programs on one or more computers in one or more locations, in which the systems, components, and techniques described below can be implemented.

The system 100 trains an image representation neural network 120 that is configured to receive an input image 102 and to process the input image to generate a representation 112 of the input image as a set of text tokens from a vocabulary of text tokens.

The tokens in the vocabulary can be any appropriate text tokens, e.g., words, word pieces, punctuation marks, characters, bytes, and so on that represent elements of text in one or more natural languages and, optionally, numbers and other text symbols that are found in a corpus of text. For example, the system 100 can tokenize a given sequence of words by applying a tokenizer, e.g., the SentencePiece tokenizer (Kudo et al., arXiv: 1808.06226) or another tokenizer, to divide the sequence into tokens from the vocabulary.

Generally, the system 100 trains the neural network 120 to generate text outputs that precisely and comprehensively describe the content of the input image 102, even if the output potentially mixes semantic concepts together. As will be described below, such properties make the representations generated by the neural network 120 effective for a wide variety of downstream tasks.

The image representation neural network 120 can have any appropriate architecture that allows the neural network 120 to map an image 102 to a representation 112 of the input image as a set of text tokens from the vocabulary of text tokens.

As a particular example, the neural network 120 can include an image backbone neural network that is configured to process the input image 102 to generate a feature representation of the input image and an encoder neural network configured to process the feature representation of the input image to generate the representation 112 of the input image 102 as a set of text tokens from the vocabulary of text tokens.

In some of these examples, the image backbone neural network can have been pre-trained on an image representation learning task. Thus, training the image representation neural network 120 can involve training the encoder neural network while holding the image backbone neural network fixed.

In others of these examples, the system 100 can train both the encoder neural network and the image backbone neural network during the training. For example, the image backbone neural network and the encoder neural network can both be trained from randomly initialized parameter values or the image backbone neural network can be fine-tuned from pre-trained parameter values while the encoder neural network is trained from randomly initialized parameter values.

The image backbone neural network and the encoder neural network can each have any appropriate architecture.

For example, the image backbone neural network can be a vision Transformer (ViT) or a convolutional neural network that process an input image to generate a feature representation of the input image that includes multiple feature vectors representing the input image.

As another example, the encoder neural network can implement attention pooling to map the feature representation to the text tokens. In this example, the encoder neural network can have a respective learned query corresponding to each text token in the representation 112, i.e., can maintain query vectors that are learned as part of the training of the neural network 120, with each of the query vectors corresponding to a different one of the text tokens in the representation 112.

Moreover, in this example, the encoder neural network can include a sequence of self-attention layer blocks and an output layer block.

Each self-attention layer block is configured to update the learned queries conditioned on the feature representation of the input image. For example, each self-attention layer block can include a self-attention layer that applies self-attention across the learned queries to update the learned queries and a cross-attention layer that updates each learned by query performing cross-attention into the feature representation.

In this example, to process the feature representation of the input image to generate the representation of the input image, the encoder neural network can process the learned queries through the sequence of self-attention layer blocks and then, after processing the learned queries through the sequence of self-attention layer blocks, process each learned query using the output layer block to generate the corresponding text token in the representation. For example, the output layer block can include a linear neural network layer that projects each learned query to one of the discrete tokens in the vocabulary. As described below, during training, the system 100 can use an “approximation” to approximate the discrete sampling of vocabulary tokens when needing to backpropagate gradients into the image representation neural network 120.

Once trained, the image representation neural network 120 can be used by an inference system 150 to perform downstream tasks.

For example, after training the image representation neural network 120, the inference system 150 can receive a query input 152 for a downstream task. The query input 152 will generally include a query image 154 and, optionally, other data, e.g., one or more other images, one or more inputs of a different modality, e.g., text or audio.

The inference system 150 processes the query image 154 using the image representation neural network 120 to generate a representation 156 of the query image 154 as a set of text tokens.

The inference system 150 can then provide the representation 156 of the query image as input to a downstream neural network 160 configured to perform the downstream task.

The downstream neural network 160 can generally be any neural network that is configured to process inputs that include text tokens from the vocabulary to generate outputs for the downstream task.

For example, the downstream neural network 160 can be a language model neural network, e.g., a large language model neural network (LLM), or a visual language model neural network (VLM). The LLM can be, e.g., a multi-modal model that processes inputs that include tokens representing multiple different modalities of data, or can be a uni-modal model that process inputs that include text tokens.

For example, the query input 152 can include the query image 154 and text and the downstream neural network 160 can be an LLM. Thus, providing the representation 156 of the query image 154 as input to the downstream neural network 160 can include providing the representation 156 of the query image 154 and the text from the query input 152 as input to the LLM instead of directly providing the query image 154 as part of the input. For example, the LLM can have been trained on text-only data and therefore not be able to directly process image data inputs.

The downstream task that is performed by the downstream neural network 160 can be any of a variety of tasks, e.g., a multi-modal dialogue task, so that the image is part of a dialogue input submitted by a user to the system and the output generated by the downstream neural network is a response to be displayed to the user.

Other examples of downstream tasks include multi-modal zero-shot or few-shot learning tasks.

More specifically, by making use of the trained representation neural network 120 and because the representations generated by the downstream neural network 120 are precise and comprehensive descriptions of the corresponding images, the downstream neural network 160 can effectively perform multi-modal tasks that require operating on images even if the downstream neural network 160 is not configured to process image data. Moreover, the downstream neural network 160 does not need to be re-trained in order to effectively perform the downstream task.

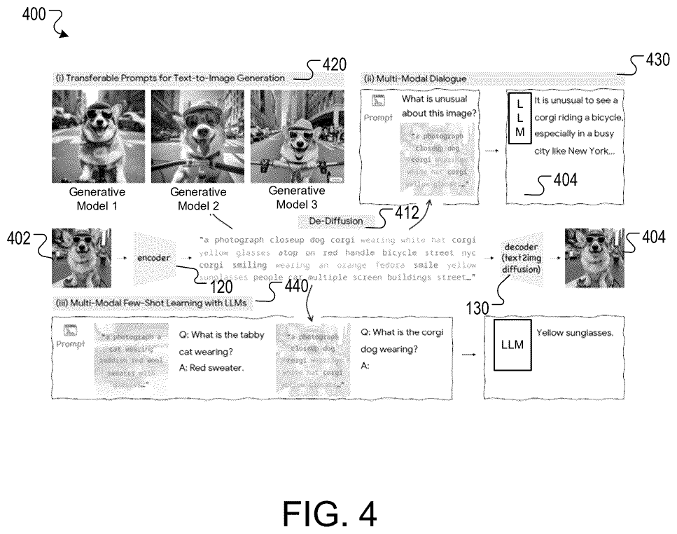

Examples of downstream tasks are described in more detail below with reference to FIG. 4.

To train the image representation neural network 120, the system 100 uses a cross-modal interface, i.e., an interface that maps from text generated by the model back to the image modality. As will be described below, this cross-modal interface is leveraged using a text-conditional image generation neural network 130.

The text-conditional image generation neural network 130 is a neural network that receives an input that includes conditioning text and processes the input to generate an output that defines an output image 132, e.g., an output image that is described by the conditioning text.

For example, the text-conditional image generation neural network 130 can be a text-conditional diffusion neural network.

In this example, the output of the text-conditional diffusion neural network that defines the output image is a denoising output.

A text-conditional diffusion neural network is a neural network that can be used to perform a reverse diffusion process to generate an output image from a given conditioning input that includes text.

To perform the reverse diffusion process, the system initializes a representation of the output image. For example, the system can sample each value in each representation from a noise distribution, e.g., a Gaussian distribution.

The system then updates the representation at each of a plurality of reverse diffusion steps (also referred to as “iterations” or “updating iterations”) using the conditional diffusion neural network. Each reverse diffusion step is associated with a noise level for the iteration. Generally, each updating iteration has a corresponding time step t and the noise level for the iteration depends on the time step. For example, the noise level can be a decreasing function of the time step t. Examples of such functions include a linear function, a cosine function, and a sigmoid function. Thus, early iterations are associated with higher noise levels and later iterations are associated with lower noise levels, resulting in the diffusion neural network gradually “denoising” the representation to generate the final representation.

As part of the updating at any given step, the system generates a denoising output for the reverse diffusion step.

The system then updates the representation of the output image using the denoising output for the reverse diffusion step.

For example, the system can map the denoising output to an initial updated representation and then apply a diffusion sampler, e.g., the DDPM (Denoising Diffusion Probabilistic Model) sampler, the DDIM (Denoising Diffusion Implicit Model) sampler or another appropriate sampler, to the initial updated representation to generate an updated representation.

Optionally, after the last reverse diffusion iteration, the system can refrain from using the diffusion sampler and can instead use the initial updated representation as the updated representation.

To generate the denoising output, the system processes a diffusion input for the reverse diffusion step that includes the representation of the output image and the conditioning input using the diffusion neural network to generate a denoising output, which can be used as the final denoising output or combined with one or more other denoising outputs, e.g., through classifier free guidance, to generate the final denoising output.

More specifically, the diffusion neural network can be any appropriate diffusion neural network that is configured to receive an input that includes a current (noisy) representation of an image and a conditioning input that includes text and to generate a denoising output. For example, the diffusion neural network can include a text encoder neural network configured to process the text input to generate an encoded representation of the text input and an image diffusion neural network configured to generate the output image over a plurality of sampling steps conditioned on the encoded representation of the text input.

In this example, the vocabulary of text tokens is the input vocabulary of the text encoder neural network.

In some implementations, the diffusion neural network performs a diffusion process in pixel space, so that the images (“representations”) operated on and generated by the diffusion neural network have values for each pixel that specify color values, e.g., RGB values or another color encoding scheme.

Examples of such diffusion neural networks include Imagen.

In some other implementations, the diffusion neural network performs a diffusion process in latent space, e.g., in a latent space that is lower-dimensional than the pixel space. That is, the images (“representations”) operated on by the diffusion neural network are latent images and the values for the pixels of the images are learned, latent values rather than color values.

Examples of such diffusion neural networks include mobileDiffusion.

In these implementations, during training, the diffusion neural network can be associated with an image encoder to encode training images into the latent space and, after training and to generate new target images, a decoder neural network that receives an input that includes a latent representation of an image and decodes the latent representation to reconstruct the image. For example, both the encoder and the decoder neural networks can be convolutional neural networks, can be self-attention neural networks, or can include both convolutional and self-attention layers.

The diffusion neural network can have any appropriate architecture that allows the neural network to map a diffusion input that includes an input representation of a data item and to map the input representation to a denoising output that has the same dimensionality as the input representation.

For example, the diffusion neural network can be a convolutional neural network, e.g., a U-Net or other architecture that maps one input of a given dimensionality to an output of the same dimensionality.

As another example, the diffusion neural network can be a Transformer neural network that processes the diffusion input through a set of self-attention layers to generate the denoising output.

As yet another example, the diffusion neural network can include both convolutional layers and self-attention layers.

The diffusion neural network can be conditioned on the conditioning input in any of a variety of ways.

As one example, the diffusion neural network can use an encoder neural network to generate one or more embeddings that represent the conditioning input and the diffusion neural network can include one or more cross-attention layers that each cross-attend into the one or more embeddings.

As another example, the diffusion neural network can include one or more other types of neural network layers that are conditioned on the one or more embeddings. Examples of such layers include Feature-wise Linear Modulation (FILM) layers, layers with conditional gated activation functions, and so on.

As another example, as will be described in more detail below, the output(s) of the encoder(s) when encoding the conditioning input can be combined, e.g., through a weighted sum, with features of the representation of the output image, and the combined features can be processed by the remainder of the diffusion neural network.

An embedding, as used in this specification, is an ordered collection of numerical values, e.g., a vector of floating point values or other types of values.

As described above, the conditioning input generally includes text. For the text conditioning input, the diffusion neural network can use a text encoder neural network, e.g., a Transformer neural network or a recurrent neural network, to generate a fixed or variable number of text embeddings that represent the conditioning text.

The diffusion input at any given updating iteration can also include data defining a noise level for the iteration. Generally, each updating iteration has a corresponding time step t and the noise level for the iteration depends on the time step. For example, the noise level can be a decreasing function of the time step t. Examples of such functions include a linear function, a cosine function, and a sigmoid function. In these cases, data identifying the noise level, the time step, or both can be embedded using an appropriate neural network, e.g., a multi-layer perceptron (MLP) and used to condition the diffusion neural network as described above for the conditioning input.

Generally, the denoising output that is generated by the diffusion neural network defines an estimate of the final image given the current image.

In some implementations, the denoising output is an estimate of the noise component of the current image, i.e., the noise that needs to be combined with, e.g., added to or subtracted to, the final image to generate the current image.

In some other implementations, the denoising output is an estimate of the final image given the current image, i.e., an estimate of the image that would result from removing the noise component of the current image.

In yet other implementations, the system parametrizes the denoising output differently, e.g., using a v-parameterization (Salimans and Ho arXiv: 2202.00512, 2022, section 4; Appendix D) or another appropriate parameterization.

In particular, this specification generally describes the generative neural network 130 being a diffusion neural network. More generally, however, the generative neural network 130 can be any appropriate generative neural network that can map a conditioning input that includes text to an output image, e.g., an auto-regressive generative neural network, a non-auto-regressive masked token generation neural network, a normalizing flows model, the generator of a generative adversarial neural network, and so on.

Generally, the text-conditional image generation neural network has been pre-trained, e.g., by the system 100 or by a different system, on a text-conditional image generation task. For example, when the text-conditional image generation neural network is a diffusion neural network, the system 100 or another system can have pre-trained the diffusion neural network on the text-conditional image generation task by optimizing any appropriate diffusion model training objective, e.g., a score matching objective.

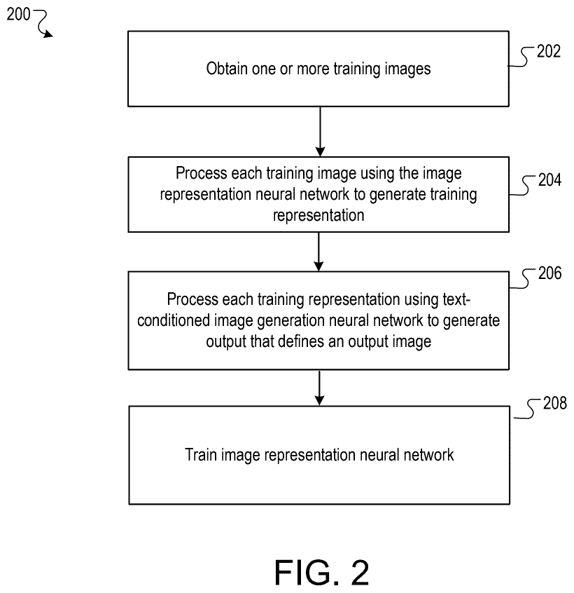

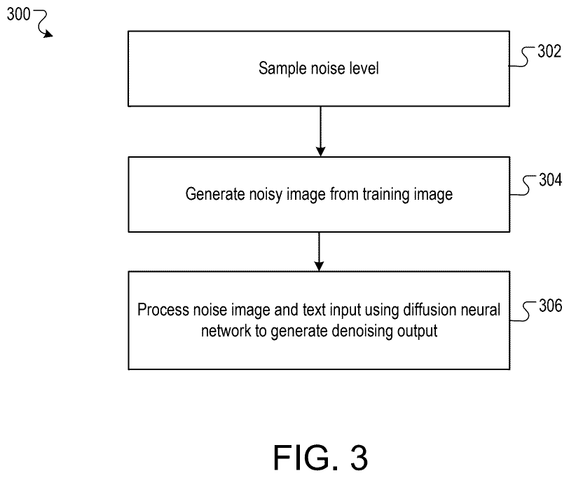

Using the text-conditional image generation neural network 130 to train the image representation neural network 120 is described in more detail below with reference to FIGS. 2 and 3.

FIG. 2 is a flow diagram of an example process 200 for training an image representation neural network. For convenience, the process 200 will be described as being performed by a system of one or more computers located in one or more locations. For example, a training system, e.g., the training system 100 depicted in FIG. 1, appropriately programmed in accordance with this specification, can perform the process 200.

The system can repeatedly perform iterations of the process 200 on different training images in order to train the image representation neural network.

In particular, the system obtains a set of one or more training images (step 202). For example, the system can sample the one or more training images from a larger set of training data.

The system then performs steps 204 and 206 for each training image in the set.

In particular, the system processes the training image using the image representation neural network to generate a training representation of the training image (step 204). As described above, the training representation of a given training image is a set of text tokens from the vocabulary of text tokens.

The system then processes a text input that includes the set of text tokens in the training representation of the training image using the text-conditioned image generation neural network to generate an output that defines an output image (step 206).

The system then trains the image representation neural network on an objective function (step 208).

The objective function includes a first term that measures, for each training image in the set, a difference between (i) a ground truth output corresponding to the training image and (ii) the output of the text-conditioned image generation neural network generated by processing the text input comprising the set of text tokens in the training representation of the training image. In some cases, the objective function also includes one or more additional terms, e.g., regularization terms or auxiliary loss terms or both.

As described above, in some cases, the text-conditional image generation neural network can be a text-conditional diffusion neural network. In this example, the output of the text-conditional diffusion neural network that defines the output image is a denoising output and the ground truth output is a ground truth denoising output corresponding to the training image.

Performing the training when the text-conditional image generation neural network is a text-conditional diffusion neural network is described below with reference to FIG. 3.

In some other cases, the text-conditional image generation neural network can be a different type of generative neural network that directly generates an output image.

In some of these examples, the ground truth output is the training image and the output of the text-conditioned image generation neural network generated by processing the text input comprising the set of text tokens in the training representation of the training image is the output image.

In others of these examples, the ground truth output can be a set of visual tokens, e.g., discrete tokens, representing the training image and the output of the text-conditioned image generation neural network generated by processing the text input comprising the set of text tokens in the training representation of the training image is a set of visual tokens, e.g., discrete tokens, representing the output image.

Generally, the system trains the image representation neural network while holding the text-conditional image generation neural network fixed. More specifically, the system backpropagates gradients of the objective function through the text-conditional image generation neural network and into the image representation neural network in order to compute a gradient of the objective function with respect to the parameters of the image representation neural network. The system can then apply an optimizer, e.g., Adam, rmsProp, Adafactor, and so on, to the gradient in order to update the parameters of the image representation neural network (while holding the text-conditional image generation neural network fixed).

In order to perform the backpropagation effectively during training, the system can make use of Gumbel-softmax as a continuous relaxation to backpropagate the gradients from the decoder through the discrete latent, i.e., use the Gumbel-softmax to allow backpropagating gradients through the discrete selection of the text tokens in the representation generated by the image representation neural network. The relaxation becomes tight as the temperature τ→0. The system can make use of an annealing schedule of temperature τ of the Gumbel-softmax to improve the stability of the training.

FIG. 3 is a flow diagram of an example process 300 for training the image representation neural network when the text-conditional image generation neural network is a text-conditional diffusion neural network. For convenience, the process 300 will be described as being performed by a system of one or more computers located in one or more locations. For example, a training system, e.g., the training system 100 depicted in FIG. 1, appropriately programmed in accordance with this specification, can perform the process 300.

The system samples a noise level (step 302). For example, the system can sample a time step t as described above from a predetermined interval, e.g., the interval between zero and one or the interval between 0 and T, where T is a positive constant, and then map the time step to a corresponding noise level σₜ. That is, as described above, each time step in the predetermined interval has a corresponding noise level.

The system generates a noisy image xt from the training image x₀ by applying noise ε to the training image x₀ in accordance with the noise level σₜ (step 304).

That is, the system samples noise ε from a noise distribution, e.g., a Gaussian distribution or other appropriate distribution, and then combines the noise ε with the training image x₀ in accordance with the noise level σₜ.

For example, the noisy image xt can satisfy:

$${x}_{t} = {α}_{t} {x}_{0} + {σ}_{t} ε ,$$

where αₜ can be equal to \sqrt{1−σₜ²}.

The system then processes the noisy image and the text input that includes the set of text tokens in the training representation of the training image using the text-conditional diffusion neural network to generate a denoising output (step 306).

As described above, the denoising output defines an estimate of the training image given the noisy image and the text input.

For example, as described above, the denoising output can be (i) the estimate of the training image, (ii) an estimate of the noise applied to the training image to generate the noisy image, or (iii) an estimate of the v-prediction output generated from the noise and the training image.

After performing the process 300 for each of the training images in the set, the system trains the image representation neural network on an objective function includes a first term that measures, for each training image in the set, a difference between (i) a ground truth output corresponding to the training image and (ii) the denoising output.

The ground truth output generally depends on the type of denoising output generated by the diffusion neural network.

For example, when the denoising output is the estimate of the training image, the ground truth output can be the training image.

As another example, when the denoising output is an estimate of the noise applied to the training image to generate the noisy image, the ground truth output can be the sampled noise described above with reference to step 304.

As yet another example, when the denoising output is an estimate of the v-prediction output, the ground truth output can be the v-prediction output generated from the noise and the training image.

FIG. 4 shows an example 400 of downstream tasks that can be performed after the training of the image representation neural network 120 (referred to as an “encoder” in the Figure).

As shown in the example 400, the image representation neural network 120 receives an image 402 of a dog and generates a text representation 410 of the image 402. As can be seen from the example, the representation 410 is a piece of information-rich text, which mixes comprehensive semantic concepts present in the image to be a “scrambled caption”. That is, although the representation 410 is not written in the style of a human user because the representation 410 mixes semantic concepts, the representation 410 is nonetheless a precise and comprehensive description of the image 402.

As described above, during training, the representation 410 is provided as input to the text-conditional image generation neural network to generate an output that defines an output image 404 for use in training the neural network 120.

After training, the text representation 410 can be used for any of a variety of tasks.

That is, the text representation 410 can act as a flexible interface between different modalities. For example, the text representation 410 can enable diverse vision-language applications to be performed on the image 402 by being used as a description of the image 402, i.e., being used in place of the image 402.

As one example 420, the text representation 410 can serve as a “transferable” prompt that can effectively be provided to different text-to-image tools (“generative models”) that causes each tool to generate an output image that matches the semantics of the input image 402 despite their different configurations and training paradigms. That is, providing the same conventional text prompt to different text-to-image tools would generally result in the tools generating different images that have different semantics due to the differing configurations of the text-to-image tools. However, by instead providing the text representation 410, because the text representation 410 is precise and comprehensive, each of the tools instead generates an output image that matches the semantics of the images generated by the other tools.

As another example 430, the text representation 410 can enable text-only chatbots to engage in multi-modal dialogue, i.e., to effectively ingest information representing images in order despite only being configured to process text. In particular, the text representation 410 can be used as part of an input prompt to a text-only LLM along with a query about the input image, which causes the text-only LLM to accurately answer the query about the input image even though the LLM was not trained to process image data.

As yet another example 440, the text representation 410 can be used to inject image context into off-the-shelf large language models to perform visual understanding tasks, e.g., to perform open-ended visual question answering, by prompting the LLM with few-shot examples that each include a respective text representation generated by the neural network 120.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks.

Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities. While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
training an image representation neural network that is configured to receive an input image and to process the input image to generate a representation of the input image as a set of text tokens from a vocabulary of text tokens, the training comprising:
obtaining a set of one or more training images;
for each training image in the set:
processing the training image using the image representation neural network to generate a training representation of the training image as a set of text tokens from the vocabulary of text tokens; and
processing a text input comprising the set of text tokens in the training representation of the training image using a text-conditioned image generation neural network to generate an output that defines an output image; and
training the image representation neural network on an objective function that includes a first term that measures, for each training image in the set, a difference between (i) a ground truth output corresponding to the training image and (ii) the output of the text-conditioned image generation neural network generated by processing the text input comprising the set of text tokens in the training representation of the training image.

2. The method of claim 1, wherein the text-conditional image generation neural network has been pre-trained on a text-conditional image generation task and wherein training the image representation neural network on the objective function comprises training the image representation neural network while holding the text-conditional image generation neural network fixed.

3. The method of claim 1, wherein the text-conditional image generation neural network is a text-conditional diffusion neural network and wherein the output of the text-conditional diffusion neural network that defines the output image is a denoising output and the ground truth output is a ground truth denoising output corresponding to the training image.

4. The method of claim 3, wherein processing a text input comprising the set of text tokens in the training representation of the training image using a text-conditioned image generation neural network to generate an output that defines an output image comprises:
sampling a noise level;
generating a noisy image from the training image by applying noise to the training image in accordance with the noise level; and
processing the noisy image and the text input using the text-conditional diffusion neural network to generate the denoising output, wherein the denoising output defines an estimate of the training image given the noisy image and the text input.

5. The method of claim 4, wherein the denoising output is one of:
(i) the estimate of the training image,
(ii) an estimate of the noise applied to the training image to generate the noisy image, or
(iii) an estimate of a v-prediction output generated from the noise and the training image.

6. The method of claim 3, wherein the text-conditional diffusion neural network comprises:
a text encoder neural network configured to process the text input to generate an encoded representation of the text input; and
an image diffusion neural network configured to generate the output image over a plurality of sampling steps conditioned on the encoded representation of the text input.

7. The method of claim 5, wherein the vocabulary of text tokens is an input vocabulary of the text encoder neural network.

8. The method of claim 1, wherein the image representation neural network comprises:
an image backbone neural network that is configured to process the input image to generate a feature representation of the input image; and
an encoder neural network configured to process the feature representation of the input image to generate the representation of the input image.

9. The method of claim 8, wherein the image backbone neural network has been pre-trained on an image representation learning task and wherein training the image representation neural network on the objective function comprises training the encoder neural network while holding the image backbone neural network fixed.

10. The method of claim 8, wherein training the image representation neural network on the objective function comprises training the encoder neural network and the image backbone neural network.

11. The method of claim 8, wherein the encoder neural network has a respective learned query corresponding to each text token in the representation, wherein the encoder neural network comprises a sequence of self-attention layer blocks and an output layer block, and wherein processing the feature representation of the input image to generate the representation of the input image comprises:
processing the learned queries through the sequence of self-attention layer blocks, wherein each self-attention layer block is configured to update the learned queries conditioned on the feature representation of the input image; and
after processing the learned queries through the sequence of self-attention layer blocks, processing each learned query using the output layer block to generate the corresponding text token in the representation.

12. The method of claim 11, wherein the output layer block is a linear neural network layer.

13. The method of claim 1, further comprising:
after training the image representation neural network:
receiving a query input for a downstream task that comprises a query image;
processing the query image using the image representation neural network to generate a representation of the query image as a set of text tokens; and
providing the representation of the query image as input to a downstream neural network configured to perform the downstream task.

14. The method of claim 13, wherein the query input comprises the query image and text, wherein the downstream neural network is a large language model, and wherein providing the representation of the query image as input to the downstream neural network configured to perform the downstream task comprises providing the representation of the query image and the text from the query input as input to the large language model.

15. The method of claim 14, wherein the downstream task is a multi-modal dialogue task.

16. The method of claim 14, wherein the downstream task is a zero-shot task or a multi-modal few-shot learning task.

17. A system comprising one or more computers and one or more storage devices storing instructions that are operable, when executed by the one or more computers, to cause the one or more computers to perform operations comprising:
training an image representation neural network that is configured to receive an input image and to process the input image to generate a representation of the input image as a set of text tokens from a vocabulary of text tokens, the training comprising:
obtaining a set of one or more training images;
for each training image in the set:
processing the training image using the image representation neural network to generate a training representation of the training image as a set of text tokens from the vocabulary of text tokens; and
processing a text input comprising the set of text tokens in the training representation of the training image using a text-conditioned image generation neural network to generate an output that defines an output image; and
training the image representation neural network on an objective function that includes a first term that measures, for each training image in the set, a difference between (i) a ground truth output corresponding to the training image and (ii) the output of the text-conditioned image generation neural network generated by processing the text input comprising the set of text tokens in the training representation of the training image.

18. The system of claim 17, wherein the text-conditional image generation neural network has been pre-trained on a text-conditional image generation task and wherein training the image representation neural network on the objective function comprises training the image representation neural network while holding the text-conditional image generation neural network fixed.

19. The system of claim 17, wherein the text-conditional image generation neural network is a text-conditional diffusion neural network and wherein the output of the text-conditional diffusion neural network that defines the output image is a denoising output and the ground truth output is a ground truth denoising output corresponding to the training image.

20. One or more non-transitory computer storage media encoded with instructions that, when executed by one or more computers, cause the one or more computers to perform operations comprising:
training an image representation neural network that is configured to receive an input image and to process the input image to generate a representation of the input image as a set of text tokens from a vocabulary of text tokens, the training comprising:
obtaining a set of one or more training images;
for each training image in the set:
processing the training image using the image representation neural network to generate a training representation of the training image as a set of text tokens from the vocabulary of text tokens; and
processing a text input comprising the set of text tokens in the training representation of the training image using a text-conditioned image generation neural network to generate an output that defines an output image; and
training the image representation neural network on an objective function that includes a first term that measures, for each training image in the set, a difference between (i) a ground truth output corresponding to the training image and (ii) the output of the text-conditioned image generation neural network generated by processing the text input comprising the set of text tokens in the training representation of the training image.
